(19) United States
(12) Patent Application Publication
(10) Pub. No.: US 2013/0283147 A1
(43) Pub. Date: Oct. 24, 2013

(54) WEB-BASED COLLABORATIVE DOCUMENT REVIEW SYSTEM

(71) Applicants: Sharon Wong, Etobicoke (CA); Brian Wong, Etobicoke (CA); Jacob Mouka, Toronto (CA)

(72) Inventors: Sharon Wong, Etobicoke (CA); Brian Wong, Etobicoke (CA); Jacob Mouka, Toronto (CA)

(21) Appl. No.: 13/450,908

(22) Filed: Apr. 19, 2012

(51) Int. Cl. G06F 17/00

(52) U.S. Cl. 715/234

(57) ABSTRACT

A method of collaboratively editing a document includes converting an originating document to a web document comprising segmented files in a markup language; storing the web document on a server; retrieving the web document to generate edits thereto from a first participant; transmitting the first participant edits to the server and associating the first edits with the web document; retrieving the web document including first participant edits to generate additional edits thereto from a second participant; transmitting the second participant edits to the server and associating the second participant edits with the web document and the first participant edits; reviewing edits from all participants by a document administrator, accepting or rejecting edits, including conflicting edits, until desired changes are made to the web document; and converting the web document including first and second participant edits into an edited document into a proprietary format.

### FIELD OF INVENTION

The invention relates to the software arts and more particularly to a system and method of enabling multiple reviewers to collaboratively review and edit a document over the Internet.

### BACKGROUND OF INVENTION

A variety of collaborative document editing systems are known in the art. These systems generally allow an author or owner of a document to distribute a document to a number of reviewers who make edits to the document which are then fed back to the author or owner who may accept or reject the edits.

The various systems tend to differ in the manner in which documents and the edits to the documents are delivered or communicated to the various participants in the document review process. The transmission of documents or the edits thereto can have an effect on the size of the files transmitted between participants, which can have discernible user effects such as poor latency. The manner in which edits are communicated and displayed can have an effect on the participant's efficacy. For example, a poor user interface can hamper the effectiveness of the review process. In addition, in many prior art systems the participants must have specialized software to be able to edit the documents, particularly if the document is written using a proprietary text editor such as Microsoft Word™.

The invention seeks to provide a web-based collaborative document review system which will facilitate the review and edit of substantially large documents over the Internet utilizing its standardized ecosystem, even when the original document is written in a proprietary format such as Microsoft Word™. To this end, the invention seeks to provide a system which utilizes a web-browser based editor. The invention also seeks to provide a non-destructive system, wherein reviewers are able to propagate edits to the author of the document without changing the original content, allowing the author to accept or reject any edits. And finally, the invention seeks to provide an easy-to-use user interface that will facilitate rapid review of a document that has been edited by potentially many people who may not all agree on how specific passages should be worded.

### SUMMARY OF INVENTION

According to a first aspect of the invention, a method and system is provided for collaboratively editing a document. The method includes: converting an originating document in a proprietary format to a web document that comprises a series of one or more segmented files in a markup language; storing the web document on a server and making the web document available to web browsing devices communicating with the server over the Internet; retrieving the web document with a first device to generate one or more edits thereto from a first participant utilizing a first web browser; transmitting the first participant edits to the server and associating the first edits with the web document; retrieving the web document including first participant edits with a second device to generate one or more additional edits thereto from a second participant utilizing a second web browser; transmitting the second participant edits to the server and associating the second participant edits with the web document and the first participant edits; converting the web document including first and second participant edits into an edited document in the proprietary format; and making the edited document available to its owner.

In a preferred embodiment the server incorporates programming in the web document so as to enable the participants to edit the text of the web document via the web browsers. The programming is preferably provided in the form of Javascript™ code.

The edits are preferably captured as edit objects that are asynchronously transmitted to the server. In the preferred embodiment the web document preferably has a tree structure and each edit object includes information identifying a leaf node in the tree, the start position in character length relative to the start of the leaf node, the type of edit, the character length of the edit and the identity of the participant that made the edit. These edit objects are preferably carried as data within the web document.

In the preferred document the web document includes an HTML file, and each participant can select whether or not to display edits. To display edits, the web browser is programmed to insert the edits within corresponding paragraph tags of the HTML document and marks the edits with a predefined tag. To remove edits from display, the web browser is programmed to remove the edits from the corresponding paragraph tags of the HTML document.

In the preferred embodiment the web browser is programmed to provide a first display screen which shows only the edits of the participant, a second display screen showing only the edits of other participants, and a third display screen showing the edits of all participants. The web browser is preferably programmed to allow the participant to make edits only in the first display.

In the preferred embodiment the web browser is programmed to display edits in different colours within a window pane showing the document text. In addition, the web browser is programmed to display a pop-up window within the window pane showing the document text in response to a participant selecting a coloured edit. The pop-up window details the edit including the original text, any change thereto, and the identity of the participant that made the edit.

In the event that two participants make conflicting edits to the document text, the web browser is programmed to show the original text in a predetermined colour. In addition, the web browser is programmed to display a pop-up window within the window pane showing the document text in response to a participant selecting a conflicting edit. The pop-up window details the conflicting edits including the identity of the participants that made the edits and the nature thereof.

### BRIEF DESCRIPTION OF DRAWINGS

The foregoing and other aspects of the invention will be better understood having reference to the accompanying drawings, wherein:

FIG. 1 is a client-server architectural block diagram of a collaborative editing system and embedded process flow according to a preferred embodiment;

FIG. 2 shows an administrative screen display provided by the server which enables a participant to upload or download a document for review;

FIG. 3 shows a screen display provided by the server which includes menu choices editing the document under review and viewing it in a merged view where changes to the text from all participants are visible;

FIG. 4 shows a formatted, printed page of a sample document;

FIG. 5 shows a screen display of the sample document in a web browser editor provided by the system as seen by a first reviewer;

FIG. 6 shows the screen display of the web browser editor after a selection of text in the sample document of FIG. 6 is deleted;

FIG. 7 shows the screen display of the web browser editor in the process of changing a selection of text in the sample document of FIG. 6;

FIG. 8 shows the screen display of the web-browser editor after the selected text in FIG. 7 is changed;

FIG. 9 shows the HTML structure of the sample document shown in FIG. 8;

FIG. 10 shows the screen display of the web-browser editor as seen by a second reviewer of the sample document;

FIG. 11 shows a screen display of the sample document as seen by the second reviewer when he or she requests to see other reviewers' edits thereto;

FIG. 12 shows the screen display of the web browser editor as seen by the second reviewer after changing some text in the sample document;

FIG. 13 shows the administrative screen display after the second reviewer has edited the sample document; and

FIG. 14 shows a “merged view” of the sample document where the edits of all reviewers are shown and a conflict exists between the edits of the first and second reviewers.

### DETAILED DESCRIPTION OF PREFERRED EMBODIMENTS

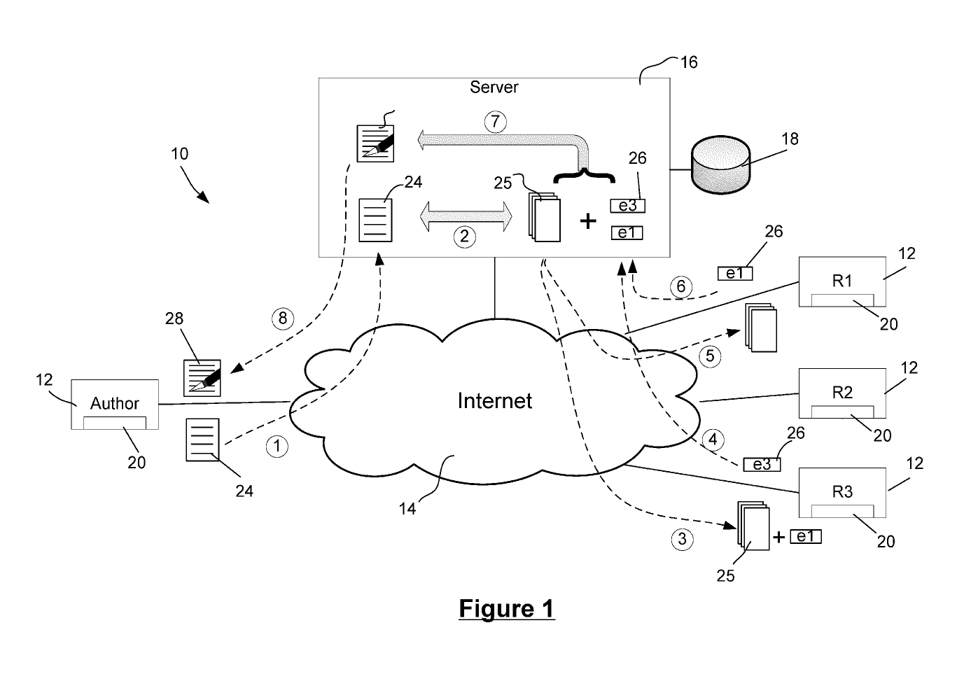

FIG. 1 shows an architectural block diagram of a collaborative editing system 10 according to a preferred embodiment of the invention. In the system 10, each participant utilizes a conventional web browsing device 12 (such as a personal computer, laptop, netbook, notepad, etc.) that is connected to the Internet 14 as well known in the art per se. Each device 12 includes a conventional web browser and communicates with a central server 16 that functions as a hub for communicating documents and edits thereto between the participants. In this description the participant that instigates a review process is referred to herein as an administrator. The administrator may be an author of a document as indicated in FIG. 1 or may be another participant. Various reviewers or editors of the document are referenced as R1, R2, R3, etc, but it should be understood that the administrator or author(s) may also be a reviewer or editor as exemplified below. In the preferred embodiment there is no limit to the number of administrators or reviewers.

The server 16 provides a repository 18 that holds one or more documents to be edited. The server 16 also supplies a client program or applet 20, preferably written in a device agnostic language, that is provided to and executed by the web browsing devices 12 as the participants utilize the system 10. For example, the applet 20 can be dynamically provided by a scripting language such as JavaScript™ embedded directly into HTML pages or files that the web browsing devices 12 load from the server from time to time as the devices 12 interact with the server.

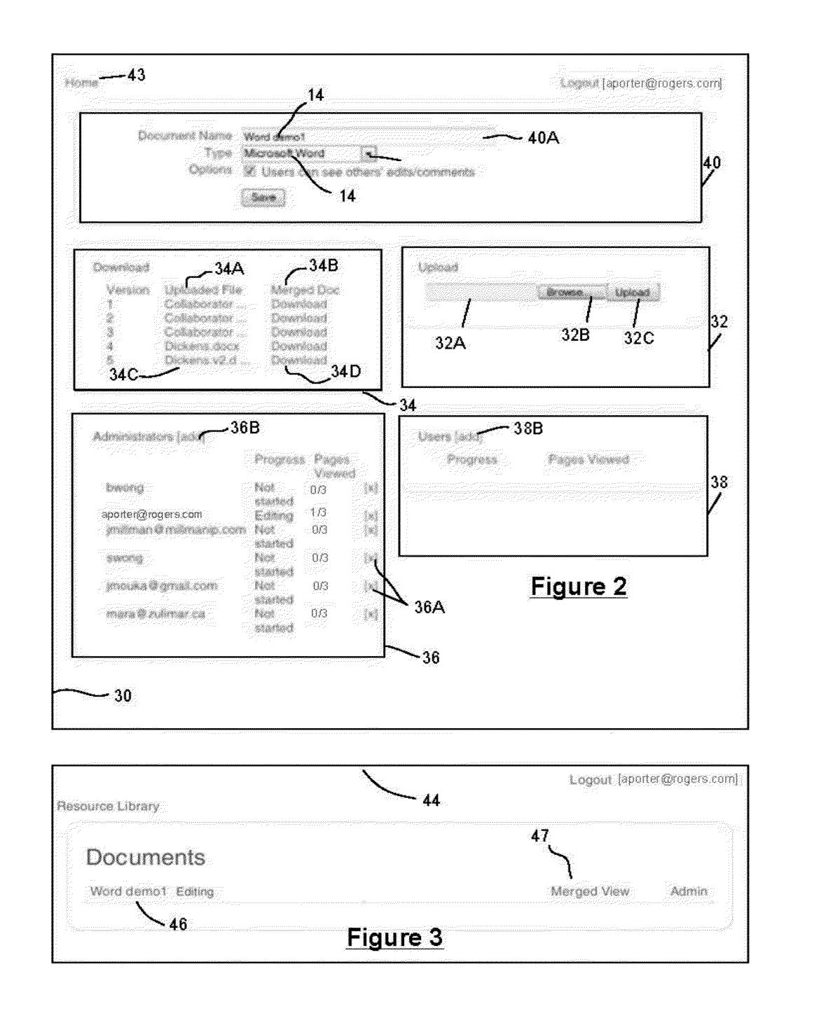

FIG. 2 shows an administration screen 30 provided by the server 16. Referring additionally to FIG. 1, as a first step in the document review process an administrator (such as the author) uploads an originating document 24 to the server 16 via an upload dialogue 32. The upload dialog 32 features an input field 32A for the location of the originating document 24 on the administrator's browsing device 12, which field can be filled in via a virtual button 32B that guides the user through a file directory, and via a virtual upload button 32C that causes the administrator's browsing device 12 to transmit the originating document 24 to the server 16. To illustrate a representative use of the system 10, FIG. 2 shows a state where an administrator (in this example “aporter”) has uploaded an originating document called “Dickens.v2.docx” which is listed as document number five in a download dialog 34.

The download dialogue 34 enables the administrator to track the history of various iterations of the document sent out for review. Each entry under “Uploaded File” 34A is a hyperlink to an originating document stored in the server repository 18. Each entry under “Merged Doc” 34B is a hyperlink to the corresponding document stored in the server repository after the document has been edited by one or more participants. Thus, for instance, link 34C will retrieve the latest version of the originating document 24, and link 34D will retrieve an edited version of this originating document (referred to herein as simply the “edited document”) 28.

The administration screen 30 also features two review dialogs 36 and 38 for users designated as administrators and ordinary users, respectively. The review dialogs 36, 38 lists all the users that are entitled to review and/or edit the originating document 24. The review dialogs are specifically correlated to the last entry in the download dialogue 34. Thus, for instance, in the example shown in FIG. 2 the originating document 24 has been reviewed by administrator “aporter” but not yet reviewed by any of the other participants who have access to this document. Links 36A call up a Javascript function that allows administrators to delete users (and any edits they may have contributed), and likewise links 36B, 38B allow administrators to add new participants to the document review process.

Finally, the administration screen 30 includes an identifier dialogue 40 which establishes a common name 42 for the originating document 24 in input field of 40A as various versions of it may be iteratively provided by the administrator(s) to the reviewers. Importantly, the type 42 of the document, e.g., Word™ or Powerpoint™ is also indicated at drop-down box 40B for the reason described next. In FIG. 2, for instance, the name of the web document corresponding to the originating document “Dickens.v2.docx” is “Word demo1”.

The “home” link 43 brings the user to a home screen 44 shown in FIG. 3.

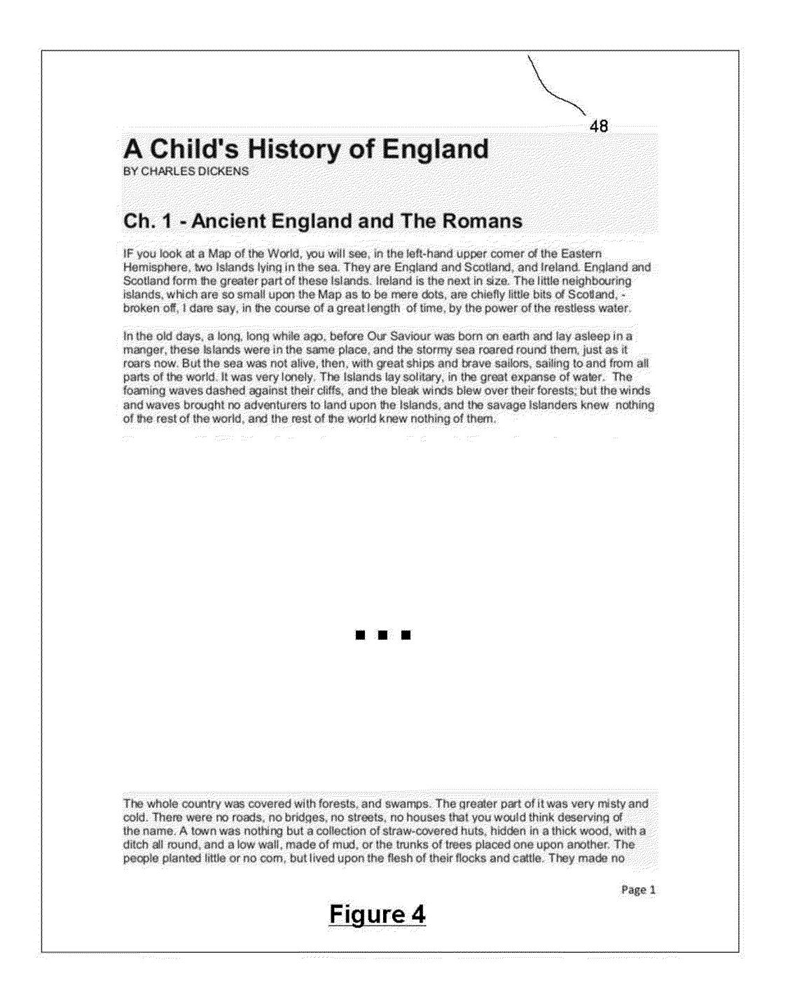

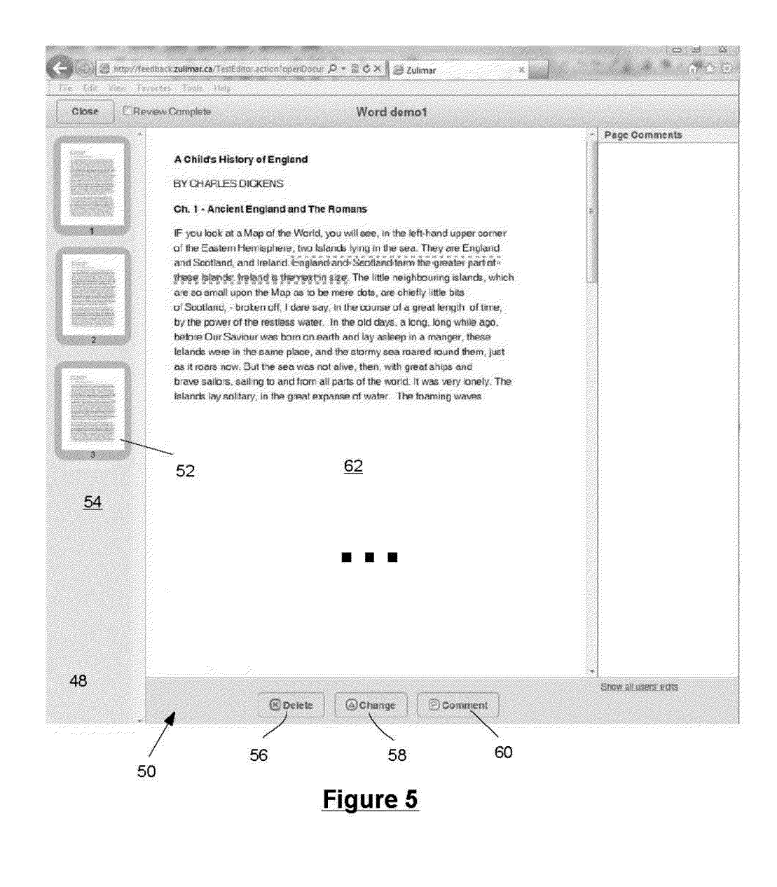

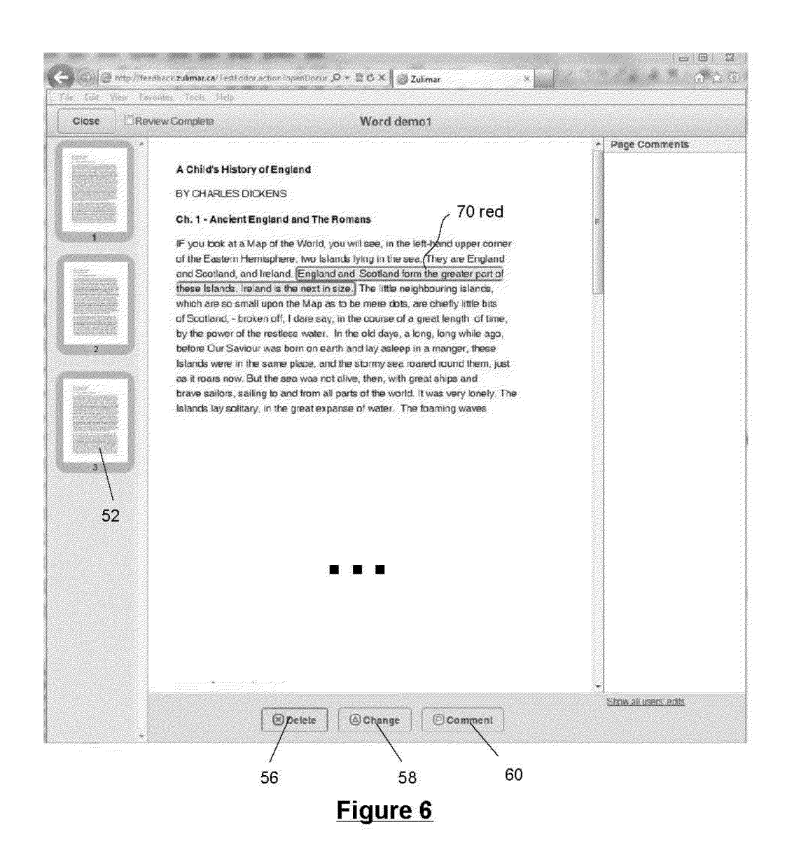

When the administrator uploads an originating document 24 to the server 16 the server converts the originating document 24 from its proprietary format to a series of related HTML files or web pages referred to herein as a “web document” 25. In the process, much of the formatting in the originating document 24 is removed (although images may be kept) and depending on its size it is preferably segmented in order to create multiple web pages, each of which is preferably sized to equal to a “page” of the originating document. (Many proprietary document editing programs such as Word™ may not mark or designate particular pages or page breaks, rather a page is often a consequence of generating a print view of the document which will depend on a variety of settings.) For example, FIG. 4 shows the first page 48 of an originating Word™ document in print view, which displays all formatting. FIG. 5 shows a view of the “Word demo 1” web document in a browser editor 50. (The web editor is accessed via link 46 in the home screen of FIG. 3.) It will be noted from FIG. 5 that much but not all the formatting of the originate in document has been stripped out in order to make the web document accessible by a variety of web browsing devices. In addition, each of the segmented HTML files representing the different pages of the web document 25 are shown as thumbnails 52 in a left window pane 54, and selecting any of the thumbnails 52 causes the browser to load the respective HTML file/web page into the browser for editing.

In the illustrated embodiment the editing tasks are actuated by a virtual delete button 56, a change button 58, and a comment button 60. The browser provides a cursor and the ability to highlight a section of the original text shown in the main window 62. The virtual buttons 56, 58 and 60 and the corresponding edits act on and are related to any text highlighted by the user.

For example, as illustrated in FIG. 5, the participant (in this case the author) has highlighted the text “England and Scotland form the greater part of these Islands. Ireland is the next in size.” When the participant clicks on the delete button 56, the applet 20 notes a first edit 70 in that the selected text is being deleted and highlights it in a first colour (e.g., red) as shown in FIG. 6.

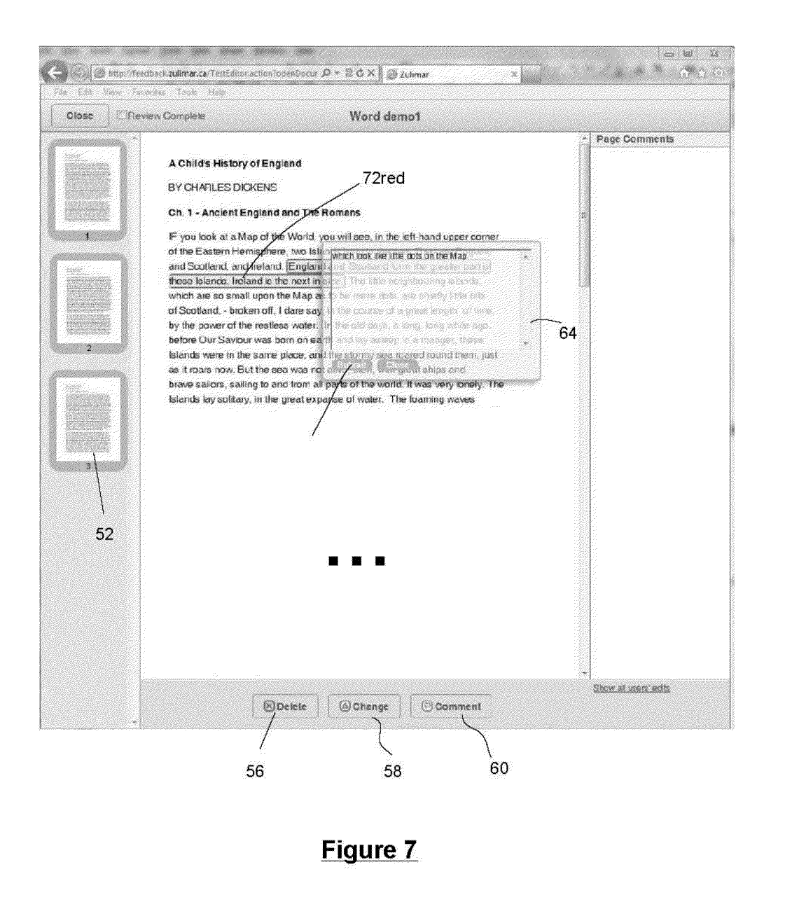

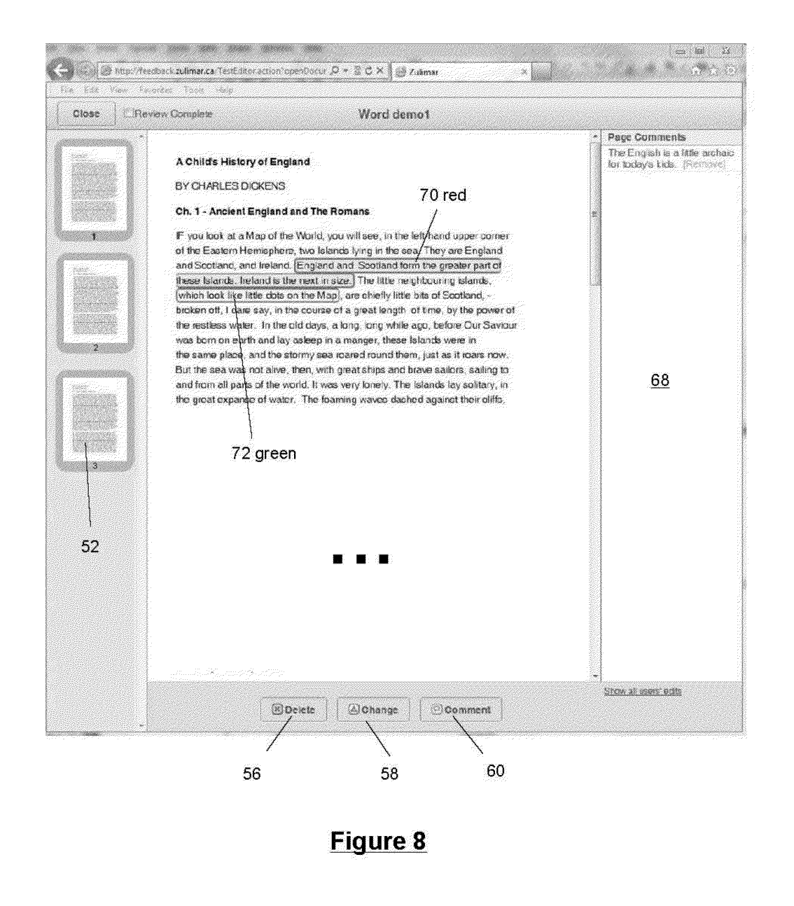

In FIG. 7, the participant highlighted the text “which are so small upon the Map as to be mere dots” and activated the change button. In response the applet 20 displayed a pop-up window 64 to allow the participant to enter new text, in this example—which look like little dots on the Map—. Upon activation of a submit button 66, the applet notes a second edit 72, displays the new text, and highlights it a second colour (e.g., green) as shown in FIG. 8.

Likewise, as seen in FIG. 8, the participant may select any text and activate the comment button 60. The applet 20 opens a pop-up window (not shown) for submission of the comment, relates the comment to the select text and displays the comment in a right sidebar pane 68. The comment may also be associated with a given page if no text is selected.

The applet 20 tracks edits based on the selected text. Edits can thus be quite granular, down to the level of individual characters.

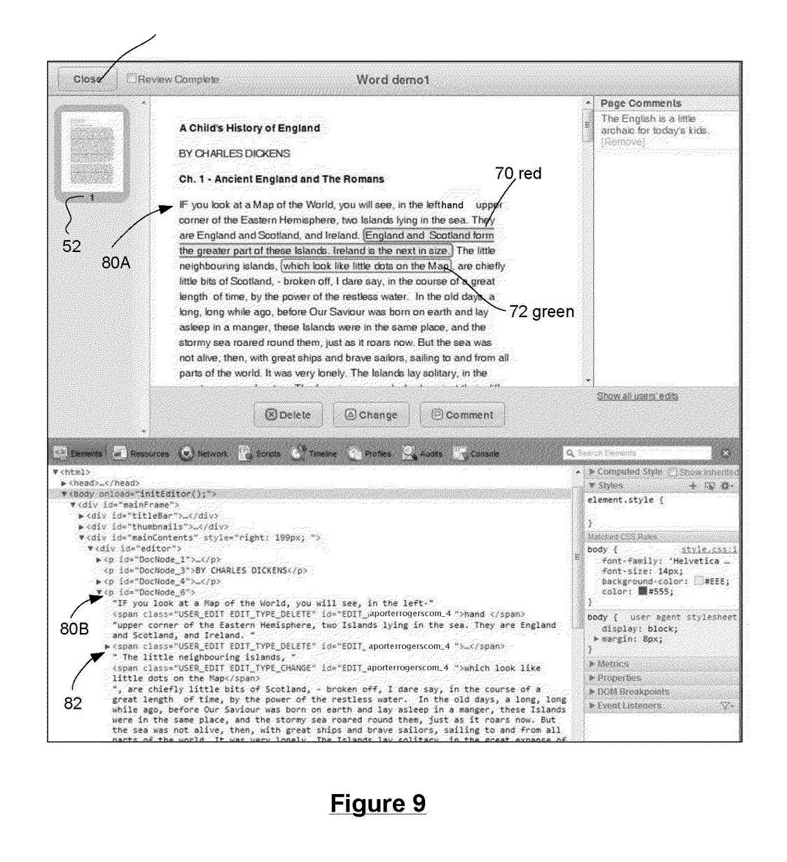

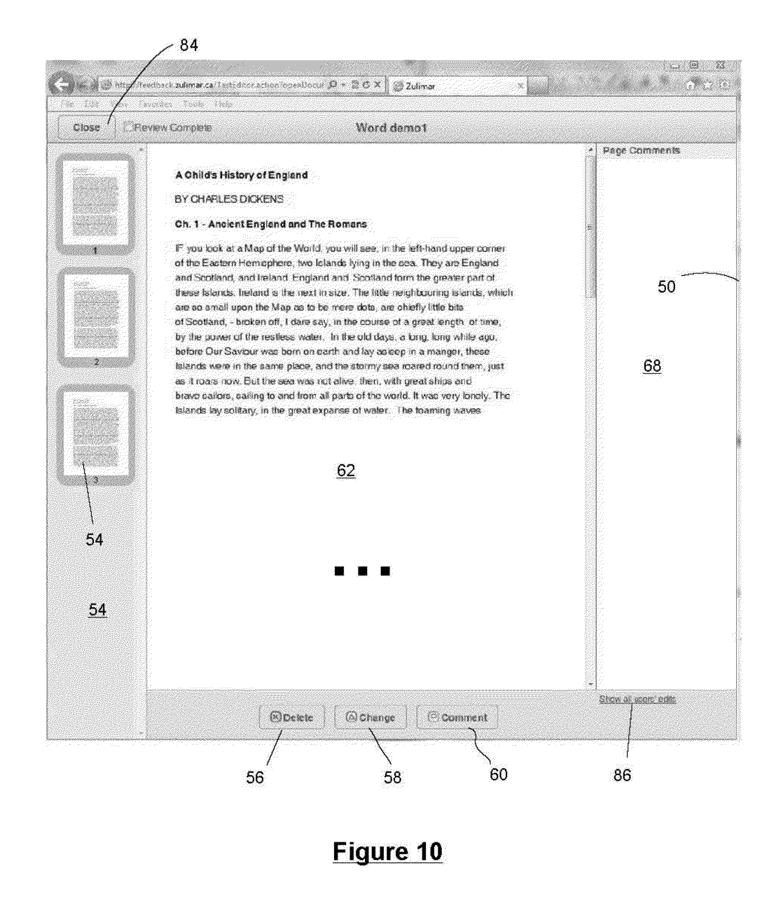

In the preferred embodiment, edits are recorded by inserting predefined tags into the HTML file is loaded into the browser. This enables the applet 20 to discern between the original text—which remains unchanged, and the edits, which are carried in the HTML file and may be selectively displayed. More particularly, when the originating document 24 is converted to the web document 25, each HTML file thereof is marked up with one or more paragraph tags. In the preferred document, the paragraphs are dynamically parsed by the browser and each paragraph tag is labeled with an identifier. See, for example, FIG. 9, where the identification of the paragraph (at reference number 80A) beginning with “IF you look at . . . ” is set to “DocNode 6” (at reference number 80B). The paragraphs represents leaf nodes in the structure of the HTML file, and edits are marked within the leaf nodes. In the illustrated embodiment, the span tag (e.g., at ref no. 82) is employed to mark the type and nature of the edit.

The applet 20 keeps a log or maintains an array of all the edits to the web document 25. The edits are stored in edit objects 26, which are associated with specific paragraphs and carried as data in the web document. The preferred structure of an edit object 26 includes the following fields:

parent—the paragraph identifier (e.g., “DocNode 6”)

offset—the character location at which the edit begins

edit type—an identifier for the type of edit, e.g., deletion, change or comment

length—the length of the edit in characters (this will be zero when there is a deletion)

new value—in the event of a change, the new text

old value—the previously existing text that is deleted or changed

id—an indication as to which participant made the edit

In the preferred embodiment the applet automatically establishes the labels for the paragraph nodes. As the browser is deterministic, and as the applet does not change the structure of the paragraphs (i.e., does not insert or delete paragraphs), every time the browser retrieves a page of the web document the browser will label the paragraphs with identical names thus enabling the edits to be uniquely applied. The drawback to this is that the applet will not allow edits to extend across paragraphs. In alternative embodiments, however, the system 10 may be programmed to statically label the paragraph nodes and thereby enable additional paragraphs to be dynamically inserted or deleted with specific labels that distinguish a new or deleted paragraph from a pre-existing one.

In the preferred embodiments, edits are not immediately propagated back to the sever. Rather, the process is carried out asynchronously, e.g., when the participant activates close button 84. Alternatively, the applet may synchronously propagate edits back to the server based on countdown timers and the like. It should be noted here that only the edit objects are transmitted to the server, and these are then associated with a particular web document.

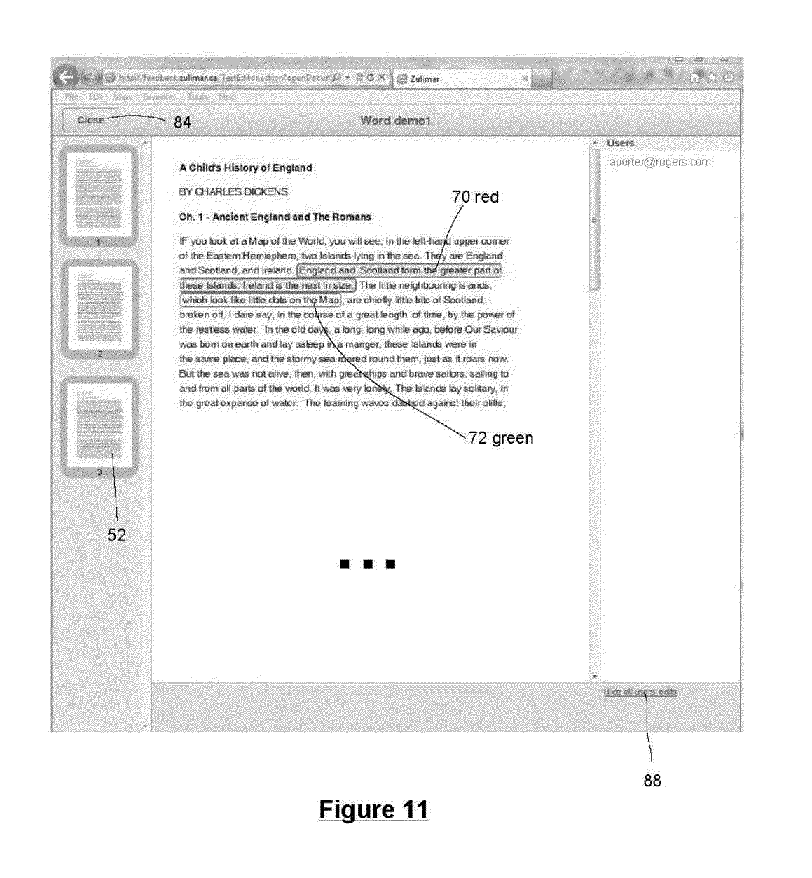

Continuing on with the example utilized in FIGS. 5-9, FIG. 10 shows a browser screen when a reviewer (e.g., “jmillman”) access the web document “Word demo 1” from the server 16 though the editing link 46 of the home screen 44 (FIG. 3). The reviewer's browser retrieves the first HTML file of the web document, which carries the edits made thereto by the first participant (in this example, “aporter”) as stored data in the form of the above mentioned edit objects. However, the applet is capable of distinguishing between the original text and the edits made thereto by other participants, and initially only displays the original text, allowing the reviewer to make his or her own edits to the text via the delete, change and comment buttons 56, 58 and 60 and related functionality. If the reviewer wishes to see the edits of the other participants, a ‘show all users’ edits' link 86 is provided. When that link 86 is activated the applet 20 embeds the edits into the HTML file whereby the browser displays the colour coded edits of the other participants as seen for example in FIG. 11. In this display the right pane 68 is utilized to indicate all user that have made edits to the document. Clicking on a specific edit (such as at reference numbers 70 or 72) will initiate a pop-up window that displays more information about the specific edit (such as who made it, what the previous text was, etc.).

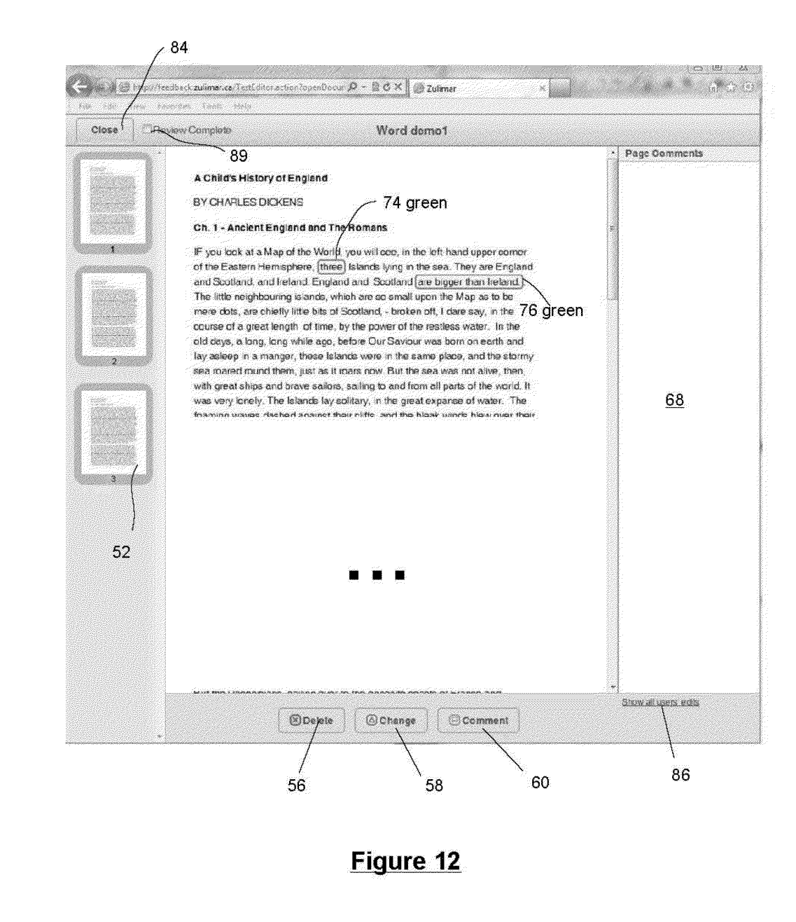

In the ‘Show all users’ view of FIG. 11 the applet does not allow the reviewer to make edits so the link “Hide all users' edits” 88 causes the applet to return to the state shown in FIG. 10 where the editing buttons 56, 58 and 60 are available. Referring additionally to FIG. 12 the reviewer may make edits relative to the original text. In the illustrated example the reviewer changed “two” to—three—and changed “form the greater part of these islands. Ireland is the next in size” to—are bigger than Ireland—, and these third and fourth change edits 74, 76 are highlighted in the second color (e.g., green).

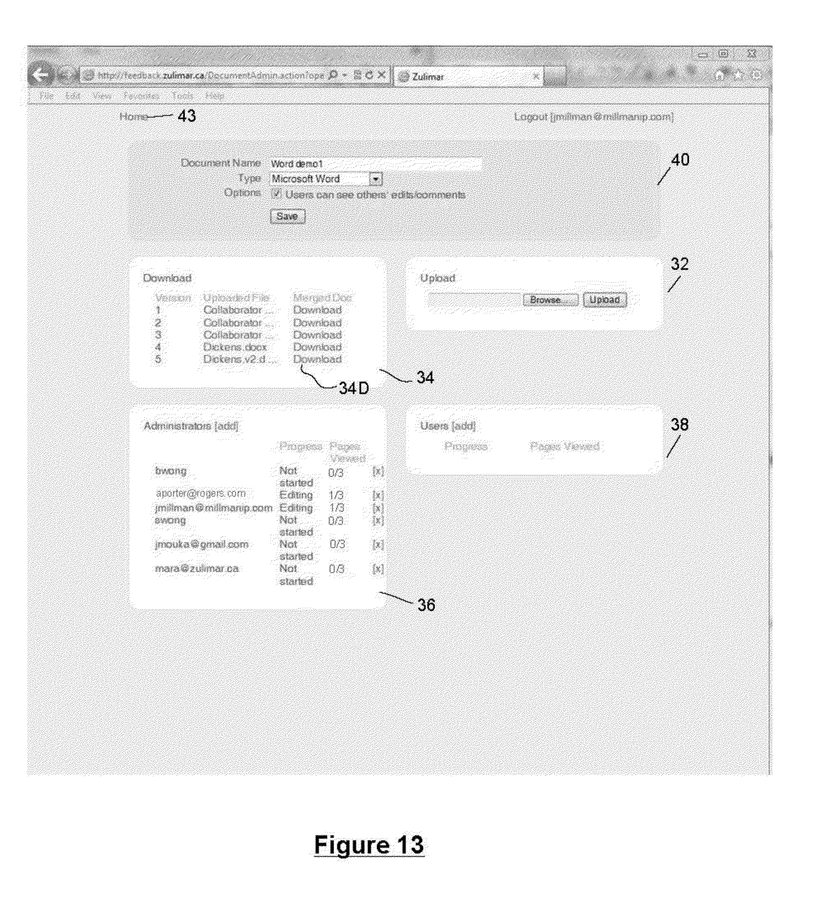

When the reviewer finishes making his or her changes to the document, the corresponding edits objects 26 are transmitted to the server. The statistics pertaining to the document are updated and thus when the administration screen 30 is next accessed as seen in FIG. 13 it shows that reviewer “jmillman” has edited the web document. (The identifier would have changed to “completed” if the reviewer had ticked off ‘Review Complete’ check box 89 when the web editor was closed.) Continuing with the example used throughout, the server has now stored edit objects 26 from “aporter” and “jmillman”.

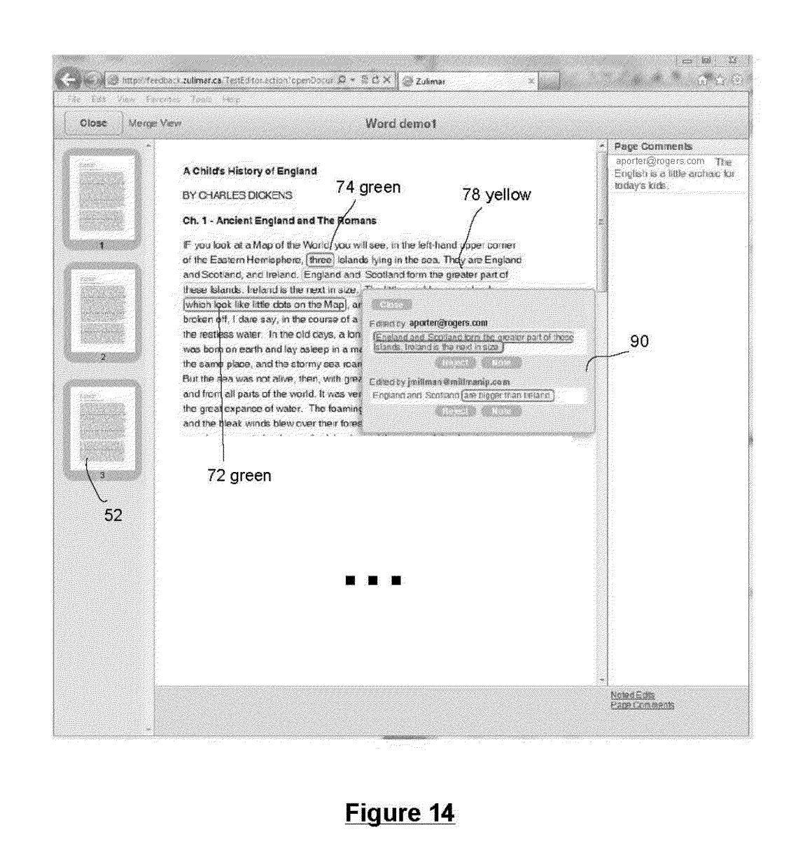

When the document “Word demo1” is next accessed, the edits from both participants can be seen. As described previously, the applet provides an original view (see, e.g., FIG. 12) where the original text is displayed along with the edits made by the instant participant. By clicking on the “Show all users' edits” link 86 the applet 20 shows edits made by the other participants (apart from the instant participant) (see, e.g., FIG. 11). In addition to this the applet provides a merged view accessible from link 47 in home screen 44 (FIG. 3) where all edits made to the document are displayed irrespective of source. For example, a merged view of the edits made by “aporter” and “jmillman” is shown in FIG. 14. The merged view is preferably for document administrators to allow them to accept or reject edits.

In the particular example shown in FIG. 14 it will be seen that the edits made by the two participants overlap each other. The applet is able to detect the overlap due to the fact that the edit objects 26 record the character start position and the character length of each edit. The applet is not able to resolve which of the two edits take precedence over the other and so it displays the original text (at reference number 78) highlighted in a third color (e.g., yellow). The highlighted areas represent hot spots on the display and when activated such as through a mouse click cause a popup window 90 to appear which shows the conflicting edits made by the two (or more) participants. Through the pop up window 90 a participant with administrator rights can select which of the edits to reject, and by implication what to keep, if anything.

In general, the technique of representing conflicts by displaying them in a unique colour is utilized by the system whenever conflicting edits from more than one participant are displayed (e.g., through the “Show all users' edits” link 86). Sometimes, when a document is prepared as a team effort the path of least resistance for the primary author is to accept all edits made to the document by others. By focusing the user's attention on conflicting edits, the author can scan the document rapidly to locate and resolve differences of opinion amongst the reviewers.

The administrator may retrieve the edited document 28 from the server through link 34D in the download dialogue 34 as seen in FIG. 2. In this event the server 16 carries out a reverse operation wherein the various edits from all participants are effected in a copy of the originating document, and this edited document 28 is returned to the administrator in its original proprietary format. Here too the edited document includes all non-conflicting edits, but in the event of an unresolved conflicting edit the original text is not changed.

Having gone through an example of an editing session, the overall collaborative document editing process can be revisited having regard to FIG. 1. As a first step in the process the author (or other participant with administrator rights) uploads an originating document 24 in a proprietary format to the server 16. At a second step, the originating document 24 is converted to a corresponding series of one or more segmented HTML files (“web document”) 25 where, preferably, much of the excess formatting in the originating document is omitted. At a third step, one or more participants (which may include the author or other reviewers) retrieve the web document to generate one or more edits thereto. As discussed above, the participants preferably edit the web document solely within the environment of a web browser and the edits are captured as granular edit objects 26 which, in a fourth step of the process, are transmitted back to the server and associated with the web document. This is shown in FIG. 1 in the flow to and from reviewer R1. Subsequently, at a fifth step in the process, additional participants may retrieve the web document 25 (along with the previously made edits 26 thereto) to effect still further edits 26 which are transmitted back to the server in a sixth step and associated with the web document. This is shown in FIG. 1 in the flow to and from reviewer R3. The editing activity may continue unabated until at a penultimate step in the process (labeled as step seven) the server 16 converts the web document 25 along with the associated edits 26 into an edited document 28 having the same proprietary format as the originating document 24. At a final (labeled eighth) step in the process, the edited document 28 is transmitted back to the author or other administrator.

Those skilled in the art will understand that a variety of modifications may be made to the embodiment described above. For example, while in the preferred embodiment the originate in file is converted from its proprietary format to the web document and vice versa on the server, that functionality may alternatively be carried out by the web browsing devices and the web document uploaded to and retrieved from the server. Similarly, those skilled in the art will appreciate that a variety of other changes and modifications may be made to the foregoing embodiments without departing from the fair meaning of the accompanying claims.

1. A system for collaboratively editing a document, comprising:
a server;
a plurality of devices, each executing a web browser, connected to the server via a communications network, wherein the web browsing devices interface with the server in a client-server system operative to:
upload an originating document in a proprietary format to the server;
convert the originating document to a web document that comprises a series of one or more segmented files in a markup language;
retrieve the web document with a first device to generate one or more edits thereto from a first participant utilizing a first web browser;
transmit the first participant edits to the server and associate the first edits with the web document;
retrieve the web document including first participant edits with a second device to generate one or more additional edits thereto from a second participant utilizing a second web browser;
transmit the second participant edits to the server and associate the second participant edits with the web document and the first participant edits;
convert the web document including first and second participant edits into an edited document in the proprietary format; and
retrieve the edited document from the server.

2. A system according to claim 1, wherein the server incorporates programming in the web document so as to enable the participants to edit the text of the web document via the web browsers.

3. A system according to claim 2, wherein the programming is provided in the form of Javascript™ code.

4. A system according to claim 2, wherein the edits are captured as edit objects that are asynchronously transmitted to the server.

5. A system according to claim 4, wherein the web document has a tree structure and each edit object includes information identifying a leaf node in the tree, the start position in character length relative to the start of the leaf node, the type of edit, the character length of the edit and the identity of the participant that made the edit.

6. A system according to claim 4, wherein the edit objects are carried as data within the web document.

7. A system according to claim 6, wherein the web document includes an HTML file, and wherein each participant can select whether or not to display edits.

8. A system according to claim 7, wherein, to display edits, the web browser is programmed to insert the edits within corresponding paragraph tags of the HTML document and marks the edits with a predefined tag.

9. A system according to claim 8, wherein, to remove edits from display, the web browser is programmed to remove the edits from the corresponding paragraph tags of the HTML document.

10. A system according to claim 9, wherein the web browser is programmed to provide a first display which shows only the edits of the participant, a second display showing only the edits of other participants, and a third display showing the edits of all participants, the web browser being further programmed to allow the participant to make edits only in the first display.

11. A system according to claim 9, wherein the web browser is programmed to display edits in different colours within a window pane showing the document text.

12. A system according to claim 11, wherein, in the event that two participants make conflicting edits to the document text, the web browser is programmed to show the original text in a predetermined colour.

13. A system according to claim 2, wherein the web browser is programmed to display edits in different colours in a window pane showing the document text.

14. A system according to claim 13, wherein the web browser is programmed to display a pop-up window within the window pane showing the document text in response to a participant selecting a coloured edit, wherein said pop-up window details the edit including the original text, any change thereto, and the identity of the participant that made the edit.

15. A system according to claim 13, wherein, in the event that two participants make conflicting edits to the document text, the web browser is programmed to show the original text in a predetermined colour.

16. A system according to claim 15, wherein the web browser is programmed to display a pop-up window within the window pane showing the document text in response to a participant selecting a conflicting edit, wherein said pop-up window details the conflicting edits including the identity of the participants that made the edits and the nature thereof.

17. A method of collaboratively editing a document, comprising:
converting an originating document in a proprietary format to a web document that comprises a series of one or more segmented files in a markup language;
storing the web document on a server and making the web document available to web browsing devices communicating with the server over the Internet;
retrieving the web document with a first device to generate one or more edits thereto from a first participant utilizing a first web browser;
transmitting the first participant edits to the server and associating the first edits with the web document;
retrieving the web document including first participant edits with a second device to generate one or more additional edits thereto from a second participant utilizing a second web browser;
transmitting the second participant edits to the server and associating the second participant edits with the web document and the first participant edits;
converting the web document including first and second participant edits into an edited document in the proprietary format; and
making the edited document available.

18. A method according to claim 17, wherein the server incorporates programming in the web document so as to enable the participants to edit the text of the web document via the web browsers, wherein the edits are captured as edit objects that are transmitted to the server.

19. A method according to claim 18, wherein the web document has a tree structure and each edit object includes information identifying a leaf node in the tree, the start position in character length relative to the start of the leaf node, the type of edit, the character length of the edit and the identity of the participant that made the edit.

20. A method according to claim 19, wherein each participant can select whether or not to display edits, and wherein, to display edits, the web browser is programmed to inserts the edits within corresponding paragraph tags of the HTML document and marks the edits with a predefined tag, and wherein, to remove edits from display, the web browser is programmed to remove the edits from the corresponding paragraph tags of the HTML document.

21. A method according to claim 20, wherein the web browser is programmed to display edits in different colours within a window pane showing the document text.

22. A method according to claim 21, wherein, in the event that two participants make conflicting edits to the document text, the web browser is programmed to show the original text in a predetermined colour.

23. A method according to claim 22, wherein the web browser is programmed to display a pop-up window within the window pane showing the document text in response to a participant selecting a coloured edit, wherein said pop-up window details the edit including the original text, any change thereto, and the identity of the participant that made the edit.
